(19) United States
(12) Patent Application Publication
(10) Pub. No.: US 2013/0176349 A1
(43) Pub. Date: Jul. 11, 2013

(54) DISPLAY DEVICE AND METHOD OF DRIVING THE SAME

(71) Applicants: Jung-Kook Park, Yongin-City (KR); Jae-Yong Kim, Yongin-City (KR); Byung-Hoon Chae, Yongin-City (KR); Joong-Yong Lee, Yongin-City (KR); Si-Baek Pyo, Yongin-City (KR)

(72) Inventors: Jung-Kook Park, Yongin-City (KR); Jae-Yong Kim, Yongin-City (KR); Byung-Hoon Chae, Yongin-City (KR); Joong-Yong Lee, Yongin-City (KR); Si-Baek Pyo, Yongin-City (KR)

(21) Appl. No.: 13/431,296

(22) Filed: Mar. 27, 2012

(30) Foreign Application Priority Data
Jan. 9, 2012 (KR) 10-2012-0002436

(51) Int. Cl. G09G 3/22; G09G 5/10

(52) U.S. Cl. 345/690; 345/75.2

(57) ABSTRACT

A display device and a method of driving such a display device including a display module and a DC-DC converter provided outside the display module to supply first and second power source voltages to the display module. The display module includes a gamma voltage generator for generating a plurality of gamma voltages from a first driving voltage and a second driving voltage and a driving voltage varying unit for correcting the first driving voltage and the second driving voltage based on a change in the first power source voltage.

### CROSS-REFERENCE TO RELATED APPLICATION

This application claims priority to and the benefit of Korean Patent Application No. 10-2012-0002436, filed on Jan. 9, 2012, in the Korean Intellectual Property Office, the entire content of which is incorporated herein by reference.

### BACKGROUND

1. Field

Embodiments relate to a display device and a method of driving the same, and more particularly, to a display device capable of effectively removing brightness deviation and a method of driving the same.

2. Description of the Related Art

Recently, various display devices capable of having reduced weight and volume relative to cathode ray tubes (CRT) have been developed. The display devices include liquid crystal displays (LCD), field emission displays (FED), plasma display panels (PDP), and organic light emitting displays (OLED).

In general, a display device includes a DC-DC converter for supplying power source voltages and a display module for applying the power source voltages and data signals from the DC-DC converter to a plurality of pixels to display a screen.

### SUMMARY

One or more embodiments provide a display device capable of correcting a first driving voltage and a second driving voltage supplied to a gamma voltage generator in accordance with a change in a first power source voltage output from a DC-DC converter to effectively remove brightness deviation generated between display devices and a method of driving the same.

One or more embodiments provide a display device, including a display module and a DC-DC converter provided outside the display module to supply a first power source voltage and a second power source voltage to the display module. The display module includes a gamma voltage generator for generating a plurality of gamma voltages from a first driving voltage and a second driving voltage and a driving voltage varying unit for correcting the first driving voltage and the second driving voltage to correspond to a change in the first power source voltage.

The driving voltage varying unit includes a voltage deviation drawing unit for drawing a deviation of the first power source voltage, a first voltage deviation correcting unit for applying the deviation of the first power source voltage to the first driving voltage to generate a corrected first driving voltage and a second voltage deviation correcting unit for applying the deviation of the first power source voltage to the second driving voltage to generate a corrected second driving voltage.

The display module includes a pixel unit including pixels that receive scan signals, data signals, the first power source voltage, and the second power source voltage, a scan driver for supplying the scan signals to the pixels, and a data driver for supplying the data signals to the pixels.

The data driver includes the gamma voltage generator and the driving voltage varying unit and generates the data signals from a plurality of gamma voltages generated by the gamma voltage generator.

The voltage deviation drawing unit compares the first power source voltage with a reference voltage to draw the deviation of the first power source voltage.

The first voltage deviation correcting unit adds and subtracts the deviation of the first power source voltage to and from the first driving voltage to generate the corrected first driving voltage. The second voltage deviation correcting unit adds and subtracts the deviation of the first power source voltage to and from the second driving voltage to generate the corrected second driving voltage.

The gamma voltage generator includes a plurality of serially connected resistors and divides the first driving voltage and the second driving voltage through the resistors to generate the plurality of gamma voltages.

The display device is an organic field emission display.

One or more embodiments provide a method of driving a display device including a DC-DC converter provided outside a display module to apply a first power source voltage to the display module includes receiving the first power source voltage to draw the deviation of the first power source voltage, applying the deviation of the drawn first power source voltage to a first driving voltage and a second driving voltage to generated the corrected first and second driving voltages, generating a plurality of gamma voltages from the corrected first and second driving voltages, and generating a plurality of data signals from the plurality of gamma voltages to supply the data signals to a plurality of pixels.

In drawing the deviation of the first power source voltage, the first power source voltage is compared with a reference voltage to draw the deviation of the first power source voltage.

In generating the corrected first and second driving voltages, the deviation of the first power source voltage is added to and subtracted from the first driving voltage and the second driving voltage to generate corrected first and second driving voltages.

In generating the plurality of gamma voltages, the corrected first and second driving voltages are divided through a plurality of serially connected resistors to generate the plurality of gamma voltages.

The display device is an organic field emission display.

One or more embodiments provide a display device capable of effectively removing the brightness deviation generated between the display devices by correcting the first driving voltage and the second driving voltage supplied to the gamma voltage generator in accordance with a change in the first power source voltage output from the DC-DC converter and a method of driving the same.

### BRIEF DESCRIPTION OF THE DRAWINGS

Features will become more apparent to those of ordinary skill in the art by describing in detail exemplary embodiments with reference to the attached drawings, in which:

FIG. 1 is a view illustrating a display device according to an exemplary embodiment;

FIG. 2 is a view illustrating an embodiment of the data driver illustrated in FIG. 1;

FIG. 3 is a view illustrating an embodiment of the gamma voltage generator illustrated in FIG. 2;

FIG. 4 is a view illustrating an embodiment of the data signal generator illustrated in FIG. 3;

FIG. 5 is a view illustrating an embodiment of a pixel according to an exemplary embodiment; and

FIG. 6 is a flowchart illustrating a method of driving a display device according to an exemplary embodiment.

### DETAILED DESCRIPTION

Korean Patent Application No. 10-2012-0002436, filed on Jan. 9, 2012, in the Korean Intellectual Property Office, and entitled: “Display Device and Driving Method Thereof” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the inventive concept to those skilled in the art.

In the drawings, when a part is coupled to another part, the part may be directly coupled to another part and the part may be electrically coupled to another part with another element interposed. In the drawings, the part that is not related to the present invention is omitted for clarity of description. The same reference numerals in different drawings represent the same element, and thus their description will not be repeated.

Hereinafter, exemplary embodiments of a display device and a method of driving the same will be described with reference to the drawings.

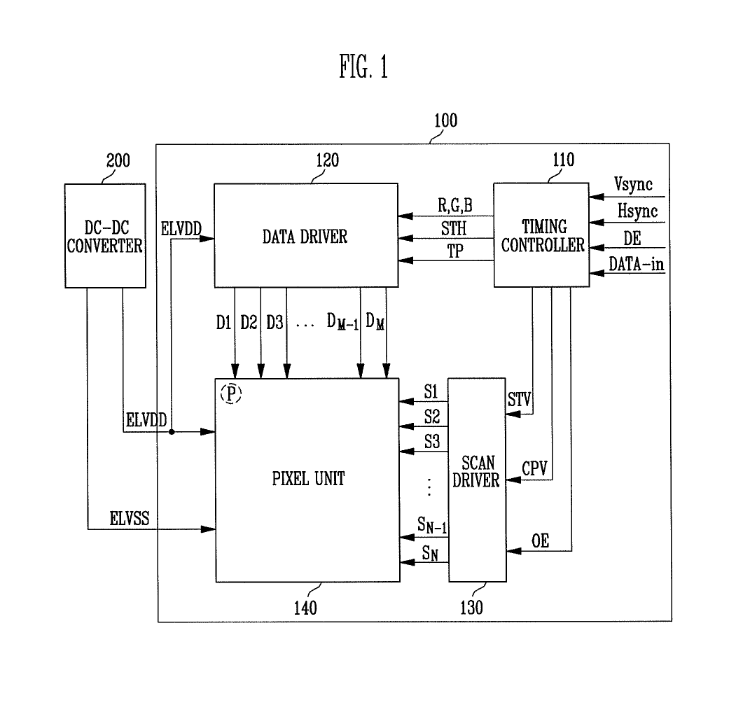

FIG. 1 is a view illustrating a display device according to an exemplary embodiment.

The display device may include a display module 100 and a DC-DC converter 200.

The DC-DC converter 200 is provided outside the display module 100 and applies a power source to the display module 100.

In detail, the DC-DC converter 200 may receives a predetermined voltage from a power source such as a battery (not shown), converts the received voltage into a first power source voltage ELVDD and a second power source voltage ELVSS employed by the display module 100, and applies the first power source voltage ELVDD and the second power source voltage ELVSS to the display module 100.

In one or more embodiments, the DC-DC converter 200 may not be built in the display module 100, and may be built, e.g., in a mobile phone set.

The display module 100 displays an image using input image data. The display module 100 may include a pixel unit 140 including a plurality of pixels P, a scan driver 130, a data driver 120, and a timing controller 110.

In one or more embodiments, the display module 100 may remove brightness deviation in accordance with a change in the first power source voltage ELVDD by generating data signals D1, D2, . . . , and DM obtained by correcting a deviation of the first power source voltage ELVDD supplied by the DC-DC converter 200 and may apply the generated data signals D1, D2, . . . , and DM to the plurality of pixels P.

Referring to FIG. 1, the timing controller 110 receives a vertical synchronizing signal Vsync, a horizontal synchronizing signal Hsync, a data enable signal DE, and an image data signal DATA_in and may output RGB data signals R, G, and B obtained by converting the image data signals DATA_in in accordance with the specification of the data driver 120 to the data diver 120. In addition, the timing controller 110 generates a horizontal synchronization start signal STH and a load signal TP for providing reference timing for outputting the data signals D1, D2, . . . , and DM from the data driver 120 to the plurality of pixels P and may output the generated horizontal synchronization start signal STH and the load signal TP to the data driver 120.

The timing controller 110 may output a vertical synchronization start signal STV for selecting a first scan line, a gate clock signal CPV for sequentially selecting a next scan line, and an output enable signal OE for controlling the output of the scan driver 130 to the scan driver 130.

The data driver 120 may include a plurality of data driver ICs. The data driver 120 receives the RGB data signals R, G, and B and the control signals STH and TP input from the timing controller 110 to generate the data signals D1, D2, . . . , and DM and outputs the generated data signals D1, D2, . . . , and DM to the respective data lines. The data signals D1, D2, . . . , and DM are applied to the plurality of pixels P.

In one or more embodiments, the data driver 120 generates the data signals D1, D2, . . . , and DM obtained by correcting the deviation of the first power source voltage ELVDD to output the data signals D1, D2, . . . , and DM to the respective data lines.

The scan driver 130 may include a plurality of scan driver ICs. The scan driver 130 applies scan signals S1, S2, . . . , and SN to the respective scan lines of the plurality of pixels P in accordance with the control signals CPV, STV, and OE provided from the timing controller 110 to sequentially scan the plurality of pixels P connected to the respective scan lines.

The pixel unit 140 may include the plurality of pixels P arranged in a secondary matrix of M×N (M and N are natural numbers).

The plurality of pixels P are driven by the scan signals S1, S2, . . . , and SN and the data signals D1, D2, . . . , and DM to emit light in accordance with the voltage levels of the data signals D1, D2, . . . , and DM. The first power source voltage ELVDD and the second power source voltage ELVSS are applied from the DC-DC converter 200 provided outside the display module 100 to the plurality of pixels P in order to drive the respective pixels P. An exemplary embodiment of the pixel P will be described below in detail with reference to FIG. 5.

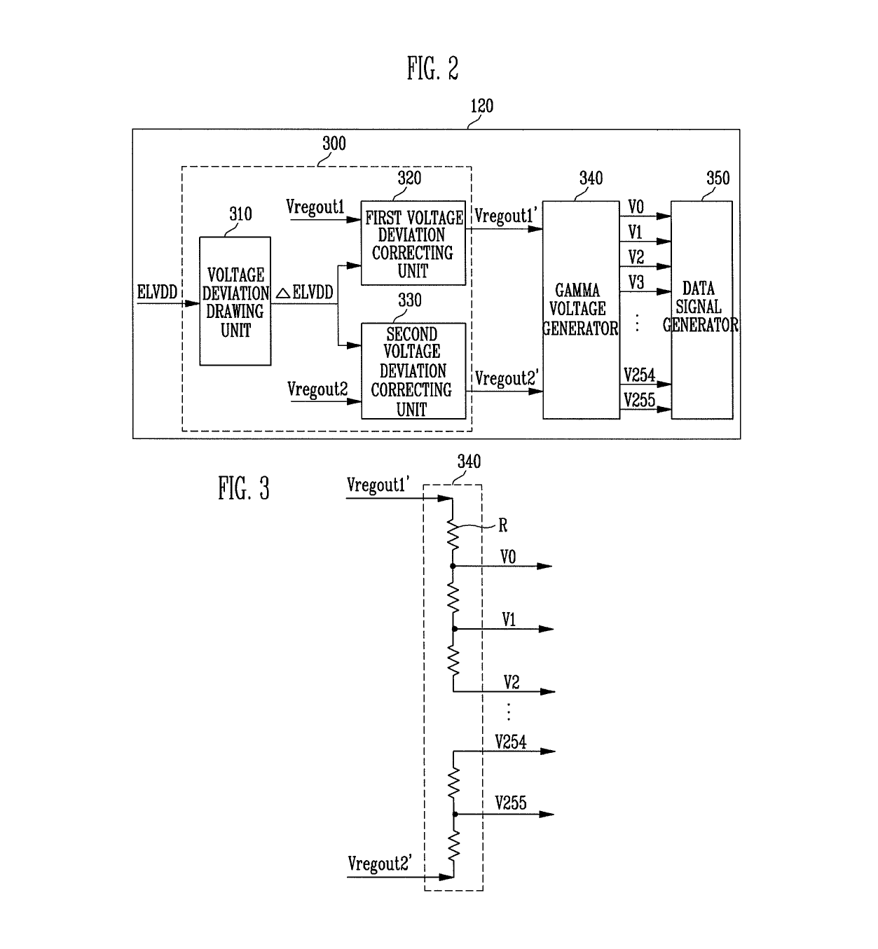

FIG. 2 is a view illustrating an exemplary embodiment of the data driver 120 illustrated in FIG. 1. FIG. 3 is a view illustrating an exemplary embodiment of a gamma voltage generator 340 illustrated in FIG. 2.

Referring to FIG. 2, the data driver 120 may include a driving voltage varying unit 300, the gamma voltage generator 340, and a data signal generator 350.

The gamma voltage generator 340 may generate a plurality of gamma voltages V0, V1, . . . , and V255 from a first driving voltage Vregout1 and a second driving voltage Vregout2. More particularly, the gamma voltage generator may generate the plurality of gamma voltages V0, V1, . . . , and V255 using driving voltages Vregout1′ and Vregout2′ corrected by the driving voltage varying unit 300 to improve brightness deviation. That is, e.g., the driving voltages Vregout1′ and Vregout2′ may correspond to Vregout1 and Vregout2, respectively, corrected by the driving voltage varying unit 300.

The driving voltage varying unit 300 may correct the first driving voltage Vregout1 and the second driving voltage Vregout2 supplied to the gamma voltage generator 340 based on a change in the first power source voltage ELVDD output from the DC-DC converter 200.

That is, in one or more embodiments, the first driving voltage Vregout1 and the second driving voltage Vregout2 may be corrected based on a change in the first power source voltage ELVDD to effectively remove the brightness deviation in accordance with the change in the first power source voltage ELVDD.

For example, the driving voltage varying unit 300 may generate the first driving voltage Vregout1′ corrected from the first driving voltage Vregout1 and the second driving voltage Vregout2′ corrected from the second driving voltage Vregout2.

In this case, the gamma voltage generator 340 generates the plurality of gamma voltages V0, V1, . . . , and V255 using the corrected first and second driving voltages Vregout1′ and Vregout2′.

In addition, the first driving voltage Vregout1 may be set to have a larger voltage level than the second driving voltage Vregout2 and the corrected first driving voltage Vregout1′ may be set to have a larger voltage level than the corrected second driving voltage Vregout2′.

In FIG. 2, the driving voltage varying unit 300 is as being included in the data driver 120. However, the driving voltage varying unit 300 may be positioned to be separated from the data driver 120.

In one or more embodiments, the driving voltage varying unit 300 includes a voltage deviation drawing unit 310, a first voltage deviation correcting unit 320, and a second voltage deviation correcting unit 330.

The voltage deviation drawing unit 310 may receive the first power source voltage ELVDD from the DC-DC converter 200 provided outside the display module 100 to draw the deviation of the first power source voltage ELVDD.

In one or more embodiments, the voltage deviation drawing unit 310 may receive the DC voltage component of the first power source voltage ELVDD from the DC-DC converter 200 provided outside the display module 100 to draw a difference between a reference voltage Vref and the DC voltage component of the first power source voltage ELVDD.

The voltage deviation drawing unit 310 obtains a difference between the applied first power source voltage ELVDD and the reference voltage Vref.

The reference voltage Vref is used by the voltage deviation drawing unit 310 in order to measure the deviation ΔELVDD of the first power source voltage.

Although not shown, a reference voltage generator for generating the reference voltage Vref may exist and the reference voltage generator may be included in the voltage deviation drawing unit 310. For example, when the first power source voltage ELVDD is 4.5V and the reference voltage Vref is 4.6V, the deviation ΔELVDD of the first power source voltage becomes −0.1V.

The operation of the voltage deviation drawing unit 310 is not limited to the above. The voltage deviation drawing unit 310 may convert the first power source voltage ELVDD into a digital value through an analog digital converter and may compare the digital value of the first power source voltage ELVDD with the digital value of the reference voltage Vref to obtain the deviation ΔELVDD of the first power source voltage.

The first voltage deviation correcting unit 320 and the second voltage deviation correcting unit 330 apply the deviation ΔELVDD, e.g., −0.1V, of the first power source voltage obtained by the voltage deviation drawing unit 310 to the first driving voltage Vregout1 and the second driving voltage Vregout2 to generate the corrected first and second driving voltages Vregout1′ and Vregout2′.

The first driving voltage Vregout1 and the second driving voltage Vregout2 may be generated by an additional voltage source in order to generate the plurality of gamma voltages V0, V1, . . . , and V255 and may be obtained by dividing an additional power source voltage applied from the DC-DC converter 200.

The deviation ΔELVDD of the first power source voltage obtained by the voltage deviation drawing unit 310 is added to and subtracted from the first driving voltage Vregout1 and the second driving voltage Vregout2 to generate the corrected first and second driving voltages Vregout1′ and Vregout2′.

At this time, the deviation ΔELVDD of the first power source voltage may be added to and subtracted from the first driving voltage Vregout1 and the second driving voltage Vregout2 so that the deviation ΔELVDD of the first power source voltage may be reflected to the voltage levels of the plurality of finally generated data signals D1, D2, . . . , and DM.

In detail, a method of applying the deviation ΔELVDD of the first power source voltage to the first driving voltage Vregout1 and the second driving voltage Vregout2 will be described.

According to the embodiment of the present invention, the deviation ΔELVDD of the first power source voltage is applied to the first driving voltage Vregout1 and the second driving voltage Vregout2 so that the deviation ΔELVDD of the first power source voltage is reflected to the data voltage Vdata applied from the data driver 120 to the pixels P.

For example, the deviation ΔELVDD of the first power source voltage may be directly added to and subtracted from the first driving voltage Vregout1 and the second driving voltage Vregout2. However, a driving voltage offset Vregout offset matched to the deviation ΔELVDD of the first power source voltage may be added to and subtracted from the first driving voltage Vregout1 and the second driving voltage Vregout2.

The driving voltage offset Vregout offset may be matched in accordance with the deviation ΔELVDD of the first power source voltage to be realized by a table. The driving voltage offset Vregout offset may be drawn by an algorithm and may be drawn by synthesizing a repetitive experiment result value.

However, a method of applying the deviation ΔELVDD of the first power source voltage to the first driving voltage Vregout1 and the second driving voltage Vregout2 is not limited to the above. Various mathematical and experimental methods may be applied.

The first driving voltage Vregout1′ and the second driving voltage Vregout2′ corrected by the first voltage deviation correcting unit 320 and the second voltage deviation correcting unit 330 are supplied to the gamma voltage generator 340.

The gamma voltage generator 340 generates the plurality of gamma voltages V0, V1, . . . , and V255 from the corrected first and second driving voltages Vregout1′ and Vregout2′.

Referring to FIG. 3, the gamma voltage generator 340 may include a plurality of serially connected resistors R and divides the corrected first and second driving voltages Vregout1′ and Vregout2′ corrected through the resistors R to generate the plurality of gamma voltages V0, V1, . . . , and V255.

The gamma voltages V0, V1, . . . , and V255 generated by the gamma voltage generator 340 are applied to the data signal generator 124. The gamma voltage generator 123 may generate different gamma voltages for the RGB data signals. In addition, the number of plurality of gamma voltages V0, V1, . . . , and V255 may vary in accordance with the structure of a resistor string and is not limited to 256.

In addition, in FIG. 3, the corrected first driving voltage Vregout1′ is illustrated as having a different value from the first gamma voltage V0. However, the resistor string may be configured such that the corrected first driving voltage Vregout1′ may be directly used as the first gamma voltage V0. The corrected second driving voltage Vregout2′ is illustrated as having a different value from the final gamma voltage V255. However, the resistor string may be configured such that the corrected second driving voltage Vregout2′ may be directly used as the final gamma voltage V255.

In one or more embodiments, only the first driving voltage Vregout1 applied to the gamma voltage generator 340 may be corrected by reflecting the deviation ΔELVDD of the first power source voltage while maintaining the second driving voltage Vregout2. However, in this case, a difference between the driving voltages applied to the gamma voltage generator 340 varies so that a brightness characteristic may change.

Therefore, in one or more embodiments, the first driving voltage Vregout1 and the second driving voltage Vregout2 applied to the gamma voltage generator 340 may be corrected together by reflecting the deviation ΔELVDD of the first power source voltage to maintain the difference between the driving voltages applied to the gamma voltage generator 340.

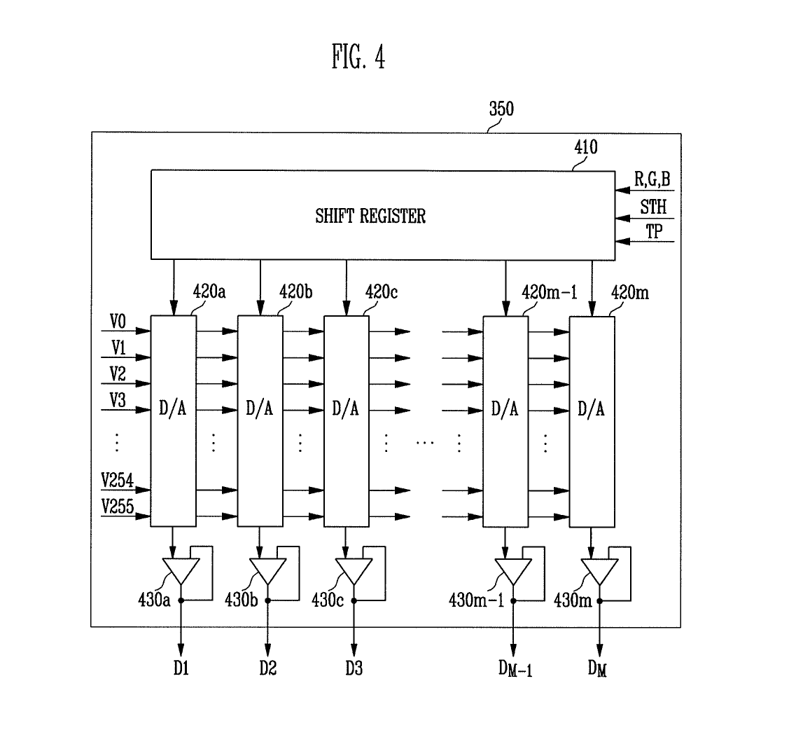

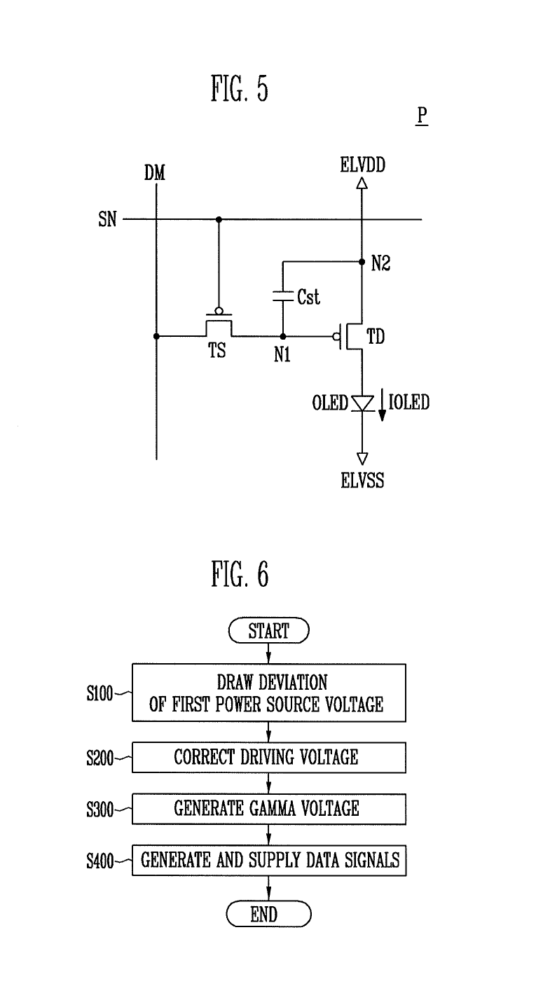

FIG. 4 is a view illustrating an embodiment of the data signal generator 350 illustrated in FIG. 3.

The data signal generator 350 receives the plurality of gamma voltages V0, V1, . . . , and V255. The plurality of gamma voltages V0, V1, . . . , and V255 are applied to a plurality of digital-analog converters 420a, 420b, . . . , and 420m.

The plurality of digital-analog converters 420a, 420b, . . . , and 420m select the gamma voltages corresponding to the RGB data signal R, G, and B among the plurality of gamma voltages V0, V1, . . . , and V255 input from the gamma voltage generator 340 and may output the selected gamma voltages to a plurality of data signal output units 430a, 430b, 430c, . . . , and 430m.

A shift register 410 receives the control signals STH and TD and the RGB data signals R, G, and B applied from the timing controller 110 to output the control signals STH and TD and the RGB data signals R, G, and B to the plurality of digital-analog converters 420a, 420b, . . . , and 420m corresponding to the data lines.

The plurality of data signal output units 430a, 430b, 430c, . . . , and 430m amplify the gamma voltages input from the digital-analog converters 420a, 420b, . . . , and 420m to output the data signals D1, D2, . . . , and DM to the data lines.

The plurality of data signal output units 430a, 430b, 430c, . . . , and 430m may be realized using a voltage follower.

FIG. 5 is a view illustrating an exemplary embodiment of a pixel.

A pixel P according to an exemplary embodiment may include a switching transistor TS, a driving transistor TD, a storage capacitor Cst, and an organic light emitting diode (OLED). When a scan signal SN is applied, the switching transistor TS is turned on and the data signal DM is applied to a first node N1. Therefore, the voltage of the first node N1 may be Vdata that is the voltage level of the data signal DM. In addition, the first power source voltage ELVDD is applied from the external DC-DC converter 200 to the pixel P. Therefore, the voltage of a second node N2 may be ELVDD.

The driving transistor TD outputs a driving current IOLED determined by a voltage difference Vgs between a gate electrode and a source electrode and a threshold voltage Vth as illustrated in EQUATION 1 to the OLED.

IOLED=k(Vgs−Vth)² [EQUATION 1]

In FIG. 5, the difference Vgs between the voltage of the gate electrode and the voltage of the source electrode is the same as a difference between the first power source voltage ELVDD and the data voltage Vdata.

The data voltage Vdata is the value generated by the data driver 120 in consideration of the deviation ΔELVDD of the first power source voltage. Therefore, although the voltage distribution of the first power source voltage ELVDD applied from the external DC-DC converter 200 to the pixel P is not corrected so that deviation exists, the deviation is offset by the deviation ΔELVDD of the first power source voltage reflected to the data voltage Vdata. Therefore, the deviation ΔELVDD of the first power source is removed from Vgs. As a result, when the driving current Ioled, from which the deviation ΔELVDD of the first power source voltage is removed, is output, the brightness deviation is removed from the display module 100 and a high quality image may be displayed.

FIG. 6 is a flowchart illustrating a method of driving a display device according to an exemplary embodiment.

Referring to FIG. 6, the method of driving the display device may include drawing the deviation of the first power source voltage (S100), correcting a driving voltage (S200), generating a gamma voltage (S300), and generating and supplying data signals (S400).

During drawing the deviation of the first power source voltage (S100), the first power source voltage ELVDD is received to determine the deviation ΔELVDD of the first power source voltage.

The deviation ΔELVDD of the first power source voltage may be calculated by a difference between the first power source voltage ELVDD and the reference voltage Vref.

During correcting the driving voltage (S200), the deviation ΔELVDD of the first power source voltage calculated from the drawing the deviation of the first power source voltage (S100) is applied to the first driving voltage Vregout1 and the second driving voltage Vregout2 to generate the corrected first and second driving voltages Vregout1′ and Vregout2′.

During correcting the driving voltage (S200), the deviation ΔELVDD of the first power source voltage is added to and/or subtracted from the first driving voltage Vregout1 and the second driving voltage Vregout2 to generate the corrected first and second driving voltages Vregout1′ and Vregout2′.

During generating of the gamma voltage (S300), the plurality of gamma voltages V0, V1, . . . , and V255 are generated from the first driving voltage Vregout1′ and the second driving voltage Vregout2′ corrected in the driving voltage correcting step (S200).

During generating of the gamma voltage (S300), the corrected first and second driving voltages Vregout1′ and Vregout2′ are divided through a plurality of serially connected resistors R to generate the plurality of gamma voltages V0, V1, . . . , and V255.

In addition, in one or more embodiments, a power source circuit for supplying the first power source voltage ELVDD may be low-priced so that it is possible to reduce the production cost of parts. In one or more embodiments, since the deviation of the first power source voltage ELVDD is compensated for by the data driver 120, although the deviation of the first power source voltage ELVDD supplied to the display module 100 may be large, an effect on the brightness of the display may be reduced and/or eliminated.

As discussed above, as the display device becomes slim, the DC-DC converter is often mounted not in the display module but in an external to the display module, and due to a voltage distribution of the DC-DC converter, deviation in the power source voltage exists between DC-DC converters and, as a result, brightness deviations may result. One or more embodiments may enable a deviation of one or more power source voltages may be internally (internal to a display module) compensated for, e.g., by a data driver, such that although a deviation of a power source voltage supplied to a display module may be large, an effect on brightness of the display may be reduced and/or eliminated.

One or more embodiments provide a display device capable of effectively removing brightness deviation generated between display devices by correcting a first driving voltage and a second driving voltage supplied to the gamma voltage generator based on a change in a first power source voltage output from a DC-DC converter and a method of driving the same.

While features have been described in connection with certain exemplary embodiments, it is to be understood that the inventive concept is not limited to the disclosed embodiments, but, on the contrary, is intended to cover various modifications and equivalent arrangements included within the spirit and scope of the appended claims, and equivalents thereof.

What is claimed is:

1. A display device, comprising:
a display module; and
a DC-DC converter provided outside the display module to supply a first power source voltage and a second power source voltage to the display module,
wherein the display module includes:
a gamma voltage generator configured to generate a plurality of gamma voltages from a first driving voltage and a second driving voltage; and
a driving voltage varying unit configured to correct the first driving voltage and the second driving voltage to correspond to a change in the first power source voltage.

2. The display device as claimed in claim 1, wherein the driving voltage varying unit comprises:
a voltage deviation drawing unit configured to determine a deviation of the first power source voltage;
a first voltage deviation correcting unit configured to apply the deviation of the first power source voltage to the first driving voltage to generate a corrected first driving voltage; and
a second voltage deviation correcting unit configured to apply the deviation of the first power source voltage to the second driving voltage to generate a corrected second driving voltage.

3. The display device as claimed in claim 2, wherein the voltage deviation drawing unit is configured to compare the first power source voltage with a reference voltage to determine the deviation of the first power source voltage.

4. The display device as claimed in claim 2,
wherein the first voltage deviation correcting unit adds and subtracts the deviation of the first power source voltage to and from the first driving voltage to generate the corrected first driving voltage, and
wherein the second voltage deviation correcting unit adds and subtracts the deviation of the first power source voltage to and from the second driving voltage to generate the corrected second driving voltage.

5. The display device as claimed in claim 1, wherein the display module comprises:
a pixel unit including pixels that are each configured to receive scan signals, data signals, the first power source voltage, and the second power source voltage;
a scan driver configured to supply the scan signals to the pixels; and
a data driver configured to supply the data signals to the pixels.

6. The display device as claimed in claim 5, wherein the data driver comprises the gamma voltage generator and the driving voltage varying unit and is configured to generate the data signals from a plurality of gamma voltages generated by the gamma voltage generator.

7. The display device as claimed in claim 1, wherein the gamma voltage generator comprises a plurality of serially connected resistors and divides the first driving voltage and the second driving voltage through the resistors to generate the plurality of gamma voltages.

8. The display device as claimed in claim 1, wherein the display device is an organic field emission display.

9. A method of driving a display device including a DC-DC converter provided outside a display module to apply a first power source voltage to the display module, comprising:
receiving the first power source voltage to determine a deviation of the first power source voltage;
applying the deviation of the received first power source voltage to a first driving voltage and a second driving voltage to generate a corrected first driving voltage and a corrected second driving voltage;
generating a plurality of gamma voltages from the corrected first and second driving voltages; and
generating a plurality of data signals from the plurality of gamma voltages to supply the data signals to a plurality of pixels.

10. The method as claimed in claim 9, wherein, determining the deviation of the first power source voltage includes comparing the first power source voltage with a reference voltage to determine the deviation of the first power source voltage.

11. The method as claimed in claim 10, wherein generating the corrected first and second driving voltages includes adding and/or subtracting the deviation of the first power source voltage with the first driving voltage and the second driving voltage to generate corrected first and second driving voltages.

12. The method as claimed in claim 9, wherein generating the plurality of gamma voltages includes dividing the corrected first and second driving voltages through a plurality of serially connected resistors to generate the plurality of gamma voltages.

13. The method as claimed in claim 9, wherein the display device is an organic field emission display device.
